(19) United States
(12) Patent Application Publication
(10) Pub. No.: US 2015/0056086 A1
(43) Pub. Date: Feb. 26, 2015

(54) ELECTRIC COMPRESSOR

(71) Applicant: KABUSHIKI KAISHA TOYOTA JIDOSHOKKI, Kariya-shi (JP)

(72) Inventors: Junya YANO, Aichi-ken (JP); Yusuke KINOSHITA, Aichi-ken (JP); Akio FUJII, Aichi-ken (JP); Junichi TAKAHATA, Aichi-ken (JP)

(73) Assignee: KABUSHIKI KAISHA TOYOTA JIDOSHOKKI, Kariya-shi (JP)

(21) Appl. No.: 14/464,094

(22) Filed: Aug. 20, 2014

(30) Foreign Application Priority Data
Aug. 23, 2013 (JP) 2013-172997

(51) Int. Cl. F04C 23/02; H02K 11/00; F04C 18/02

(52) U.S. Cl. CPC F04C 23/02; F04C 18/0215; H02K 11/0094
USPC 417/410.5

(57) ABSTRACT

An electric compressor includes a housing accommodating therein a compression mechanism and an electric motor which drives the compression mechanism through a rotating shaft thereof, and an inverter cover which is joined to the housing and accommodates therein an inverter circuit portion. The inverter circuit portion is supported by a base member which is mounted to the housing and includes electrolytic capacitors mounted to the base member in such an orientation that the longitudinal direction of the electrolytic capacitors intersect the axis of the rotating shaft and a capacitor holder for housing the electrolytic capacitors. The electrolytic capacitors and the capacitor holder are disposed at a position radially inward of mounting legs of the base member and also radially inward of an imaginary extension extending in the axial direction.

### BACKGROUND OF THE INVENTION

The present invention relates to an electric compressor.

Japanese Unexamined Patent Application Publication No. 2013-36394 discloses an electric compressor having therein a compression mechanism, a motor for driving the compression mechanism, and an electric circuit which controls the motor. The electric circuit includes a motor control circuit, an inverter, a smoothing capacitor which smoothes the power to the inverter, and a noise filter which removes noise. The electric circuit is disposed in an inverter housing, which is aligned in series with a compression housing accommodating the compression mechanism and a motor housing accommodating the motor. The motor control circuit and the electronic components constituting the inverter are disposed on a first printed circuit board. The smoothing capacitor, and a noise reduction coil and a noise reduction capacitor that constitute the noise filter are disposed on a second printed circuit board. The smoothing capacitor, the noise reduction coil, and the noise reduction capacitor mounted to the second printed circuit board are large in size, weight and height dimension and hence subject to vibrations from the compressor. Therefore, these components of the second printed circuit board are assembled by molding with a resin.

In the electric compressor disclosed in the above-cited Publication, the smoothing capacitor, the noise reduction coil and the noise reduction capacitor, which are mounted to the surface of the second printed circuit board that is opposed to the bottom wall of the inverter housing accommodating the electric circuit have a large height dimension as measured perpendicularly to the second printed circuit board. Specifically, the dimension of the electric compressor which is composed of serially connected three housings is large as measured in the direction in which the housings are connected, that is in the axial direction of the compression mechanism or the rotating shaft of the motor. Furthermore, the housing for the second printed circuit board is provided so as to protrude radially outward of the compression housing and the motor housing for the compression mechanism and the motor. If a vehicle equipped with such electric compressor has a collision, an impact caused by the collision tends to act on the inverter housing that protrudes radially outward of the other housings of the compressor, and the collision load acting on the housing then acts on the smoothing capacitor on the second printed circuit board at the protruding portion, with the result that the smoothing capacitor is deformed or damaged. If an electrolytic capacitor is used as the smoothing capacitor, such deformation or damage may cause fluid leakage and hence electric leakage.

The present invention, which has been made in view of the above-described problems, is directed to providing an electric compressor for a vehicle that reduces the collision load applied to a smoothing capacitor in the compressor in the event of a collision of the vehicle.

### SUMMARY OF THE INVENTION

In order to solve the above-identified problems, in accordance with the present invention, in an electric compressor, a compression mechanism which compresses and discharges fluid, an electric motor which drives the compression mechanism through a rotating shaft and a drive circuit portion which controls operation of the electric motor are disposed along the axis of the rotating shaft. The electric compressor includes a housing which accommodates therein the compression mechanism and the electric motor and a cover which is joined to the housing and accommodates therein the drive circuit portion. The drive circuit portion is supported by a base portion which is mounted to the housing. The drive circuit portion has a capacitor which is mounted to the base portion in such an orientation that the longitudinal direction of the capacitor intersects the axis of the rotating shaft and a capacitor holder for housing the capacitor. The base portion has a plurality of receiving portions into which fasteners are tightened. The capacitor and the capacitor holder are disposed at a position radially inward of the receiving portions and also radially inward of an imaginary extension of an outline of the housing, the imaginary extension extending in the axial direction.

Other aspects and advantages of the invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention together with objects and advantages thereof, may best be understood by reference to the following description of the embodiments together with the accompanying drawings in which:

FIG. 1 is a cross-sectional view schematically showing the configuration of an electric compressor according to an embodiment of the present invention;

FIG. 2 is an exploded perspective view showing an inverter circuit portion and an inverter cover of the electric compressor of FIG. 1;

FIG. 3 is a perspective view showing a capacitor holder and other components fixed to a base member thereof;

FIG. 4 is a plan view showing the capacitor holder and other components fixed to the base member;

FIG. 5 is a perspective exploded view showing the capacitor holder, an electrolytic capacitor and a noise reduction coil; and

FIG. 6 is a cross-sectional view taken along line VI-VI in FIG. 4.

### DETAILED DESCRIPTION OF THE EMBODIMENTS

The following will describe embodiment of the present invention with reference to the accompanying drawings.

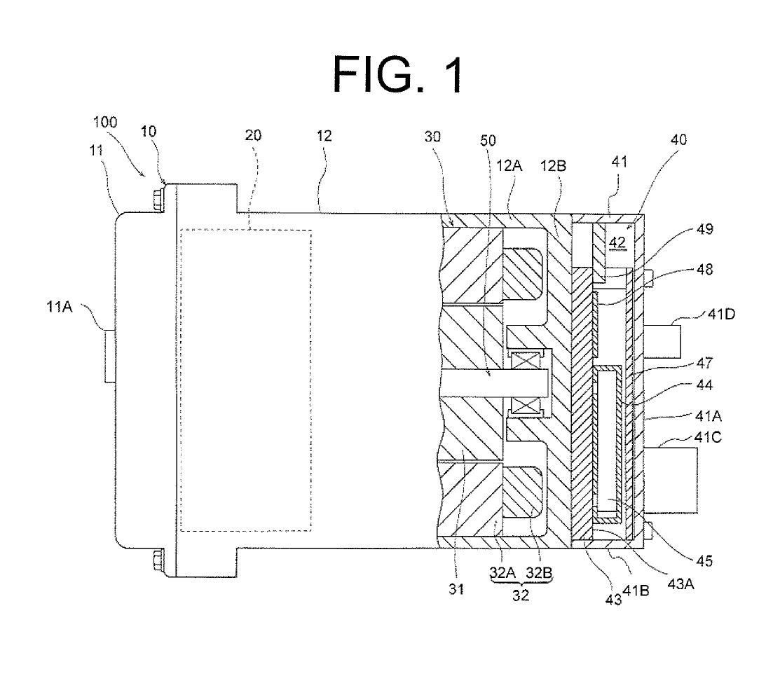

Referring to FIG. 1, an electric compressor 100 according to the embodiment of the present invention is shown. In the following description, the electric compressor 100 is a scroll type electric compressor that is used for and installed in a vehicle and draws in, compresses and discharges refrigerant gas.

The electric compressor 100 includes a housing 10 which is composed of a lid-shaped discharge housing 11 made of metallic material (aluminum alloy) and a suction housing 12 which is also made of metallic material (aluminum alloy). The suction housing 12 has a cylindrical shape having a closed end, and is connected with the discharge housing 11 at their respective open ends. The electric compressor 100 further includes a resin inverter cover 41 having a shape of a cylinder which has a closed end and accommodates therein an inverter circuit portion 40. The inverter cover 41 is connected at an open end thereof to the closed end of the suction housing 12 which is on the side opposite to the discharge housing 11.

The suction housing 12 has a cylindrical peripheral wall 12B, and an end wall 12A forming a closed end of the peripheral wall 12B. The peripheral wall 12B has therethrough at a position adjacent to the end wall 12A a suction port (not shown) which is connected to an external refrigerant circuit.

The discharge housing 11 has through the lid portion thereof opposite to the suction housing 12 a discharge port 11A which is connected to the external refrigerant circuit.

The suction housing 12 accommodates therein a scroll compression mechanism 20 for compressing refrigerant gas and an electric motor 30 for driving the compression mechanism 20. Although not shown in the drawing, the compression mechanism 20 includes a fixed scroll which is fixed within the suction housing 12 and a movable scroll which is disposed so as to face the fixed scroll and is operatively connected to a rotating shaft 50 extending in the suction housing 12 in the axial direction thereof. The rotating shaft 50 is supported rotatably within the suction housing 12 and corresponds to the rotary shaft of the present invention.

A stator 32 is fixed to the inner peripheral surface of the peripheral wall 12B of the suction housing 12. The stator 32 has a cylindrical stator core 32A fixed to the inner peripheral surface of the peripheral wall 12B and a winding 32B wound around the teeth (not shown) of the stator core 32A.

The rotating shaft 50 is passed through a cylindrical space surrounded by the stator core 32A. A cylindrical rotor 31 is fixed to the rotating shaft 50 for rotation therewith so that the outer surface of the rotor 31 and the inner peripheral surface of the stator core 32A face each other.

The discharge housing 11, the suction housing 12 and the inverter cover 41 are connected serially along the axis of the rotating shaft 50.

The inverter cover 41 has a cylindrical peripheral wall 418 and an end wall 41A forming the closed end of the peripheral wall 41B. The inverter cover 41 is connected at the open end thereof to the end wall 12A of the suction housing 12 thereby to form therein an inverter chamber 42 with the suction housing 12.

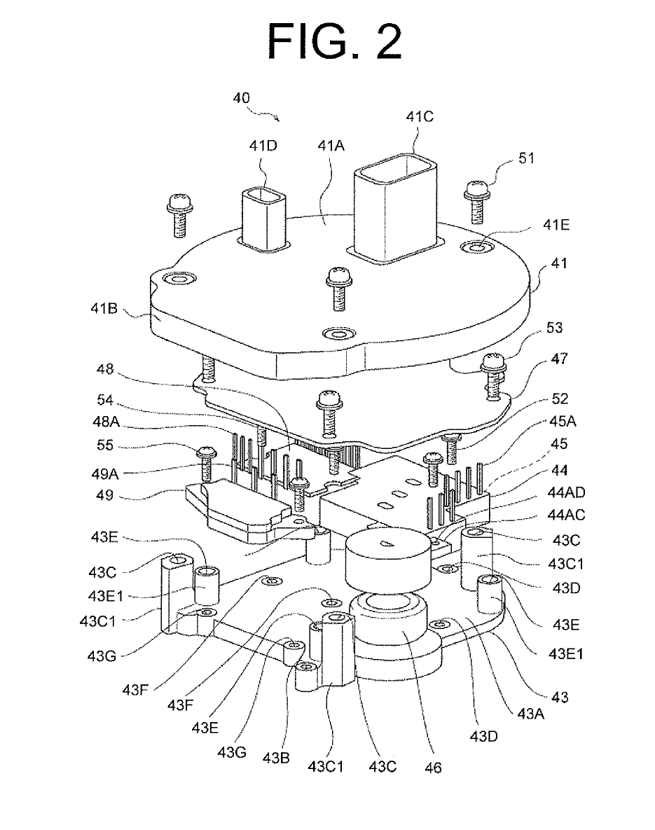

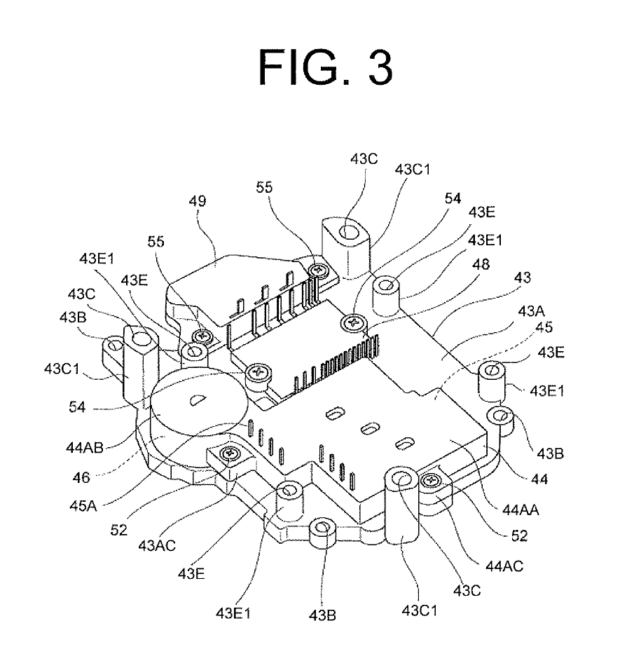

As shown in FIGS. 2 and 3, in the inverter chamber 42, a base member 43 which is made of a metal such as an aluminum alloy and plate-like having both surfaces, is fixed to the outer surface of the end wall 12A of the suction housing 12 with screws. The base member 43 is disposed so that the both surfaces extend substantially perpendicularly to the axis of the rotating shaft 50. The inverter cover 41 is fixed to the suction housing 12 with screws 51 via the base member 43.

The base member 43 corresponds to the base portion and the screws 51 to the fastening members of the present invention.

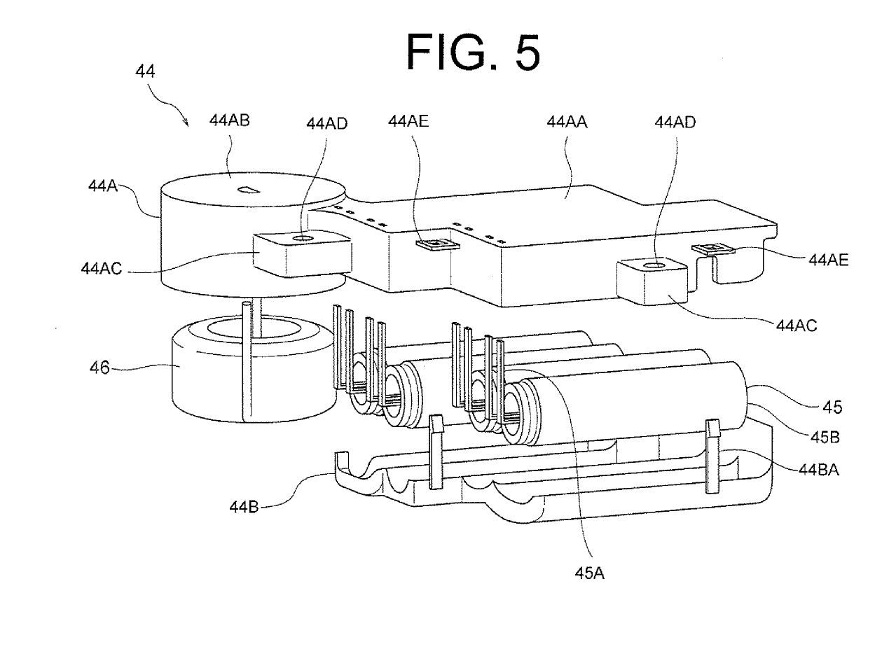

One of surfaces of the base member 43, which is on the side that is opposite to the end wall 12A, is designated as surface 43A. In the inverter chamber 42, a capacitor holder 44 made of a resin is fixed with screws 52 on the surface 43A of the base member 43. The capacitor holder 44 houses therein a plurality of electrolytic capacitors 45 (see FIG. 5) and a noise reduction coil 46.

Furthermore, a circuit board 47 is fixed with screws 53 to the base member 43 on the surface 43A side thereof with the mounting surface of the circuit board 47 extending substantially parallel to the base member 43. Specifically, the circuit board 47 is disposed so that the mounting surface thereof is substantially perpendicular to the axis of the rotating shaft 50. Each electrolytic capacitor 45 has a busbar 45A and is electrically connected to the circuit board 47 via the busbar 45A. The busbar 45A passes through the capacitor holder 44 which is disposed between the circuit board 47 and the base member 43. The screws 53 correspond to the fastening members of the present invention.

A power semiconductor module 48 which controls the power to the electric motor 30 is also fixed with screws 54 on the surface 43A of the base member 43. The power semiconductor module 48 is electrically connected via terminals 48A thereof to the circuit board 47.

Furthermore, an inner connector 49 is fixed with screws 55 on the surface 43A of the base member 43. The inner connector 49 is electrically connected to the circuit board 47 and the winding 32B of the stator 32 via terminals 49A of the inner connector 49. The electrolytic capacitors 45, the noise reduction coil 46, the circuit board 47, the power semiconductor module 48 and the inner connector 49 cooperate to form the inverter circuit portion 40 serving as the drive circuit portion of the present invention for controlling the electric motor 30.

The inverter circuit portion 40 controls the power to the electric motor 30 so that the electric motor 30 drives to rotate the rotor 31 and hence the rotating shaft 50 at a controlled speed. In the compression mechanism 20, the movable scroll (not shown) is driven by the rotating shaft 50 to make an orbital motion, and refrigerant gas drawn in through the suction port from the external refrigerant circuit is introduced into a compression chamber formed between the fixed scroll and the movable scroll through the suction housing 12. The refrigerant gas is compressed in the compression chamber and the compressed refrigerant gas is discharged into the external refrigerant circuit through the discharge port 11A.

The following will describe in detail the configurations of the base member 43 and the capacitor holder 44.

Referring to FIGS. 2 to 4, threaded holes 43B to 43G are formed in the base member 43, which correspond to the screws 51 to 54, respectively.

The base member 43 has in the periphery thereof a plurality of first threaded holes 43B which are formed through the base member 43 and through which screws are threadedly inserted for fixing the base member 43 to the end wall 12A (see FIG. 1) of the suction housing 12. The base member 43 is fixed to the end wall 12A by tightening the screws which are passed through the first threaded holes 43B.

The base member 43 has in the periphery thereof a plurality of columnar first mounting legs 4301 projecting from the surface 43A of the base member 43. Each of the first mounting legs 4301 has in the end thereof a second threaded hole 43C into which a screw 51 is threadedly inserted to fix the inverter cover 41 to the base member 43 and also to the end wall 12A of the suction housing 12. The inverter cover 41 is fixed at the end wall 41A thereof to the base member 43 with the screws 51 which are passed through mounting holes 41E formed through the end wall 41A and inserted into the second threaded holes 43C. In this case, the inverter cover 41 is fixed with the peripheral wall 41B thereof abutted in contact with the end wall 12A (see FIG. 1) of the suction housing 12 and surrounding the periphery of the base member 43. A high voltage connector 41C and a communication connector 41D are projected from the end wall 41A. The cross-sectional profile of the peripheral wall 41B taken perpendicular to the axis of the rotating shaft 50 is substantially the same as that of the peripheral wall 12B (see FIG. 1) of the suction housing 12 over the entire peripheries thereof. The first mounting legs 43C1 herein correspond to the receiving portions of the present invention.

The base member 43 has in the periphery thereof a plurality of columnar second mounting legs 43E1 projecting from the surface 43A of the base member 43. Each of the second mounting legs 43E1 has in the end thereof a fourth threaded hole 43E. The circuit board 47 is fixed to the base member 43 in parallel relation thereto with the screws 53 which are inserted through the circuit board 47 and into the fourth threaded holes 43E. The second mounting legs 43E1 herein correspond to the receiving portions of the present invention.

The base member 43 has in the periphery thereof a plurality of third threaded holes 43D into which the screws 52 are tightened to fix the capacitor holder 44 to the base member 43. The third threaded holes 43D are not formed through the base member 43, but formed halfway in the base member 43. The capacitor holder 44 is fixed to the base member 43 by tightening the screws 52 passed through mounting holes 44AD formed through fixation tabs 44AC projecting outwardly from the capacitor holder 44 and inserted into the third threaded holes 43D.

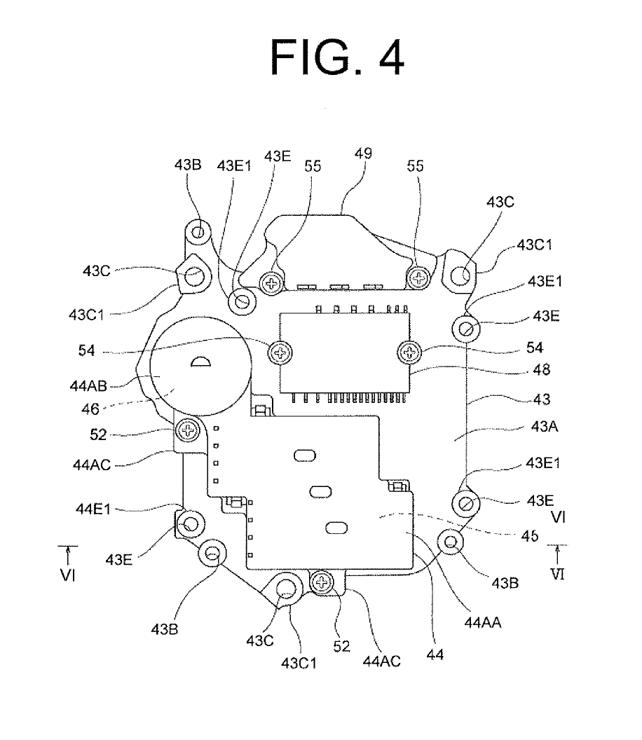

Now referring to FIG. 5, the capacitor holder 44 includes a first portion 44AA covering the electrolytic capacitors 45 and a second portion 44AB formed integrally with the first portion 44AA and covering the coil 46. The capacitor holder 44 which is fixed to the base member 43 is disposed at a position radially inward of the first mounting legs 43C1 and the second mounting legs 43E1, except a part of the second portion 44AB and the fixation tab 44AC. In other words, the capacitor holder 44 is disposed within a region having a boundary defined by the positions of the first and second mounting legs 43C1, 43E1 (see FIG. 4). Furthermore, the cross-sectional profile of the peripheral wall 41B of the inverter cover 41 taken along a plane that is perpendicular to the axis of the rotating shaft 50 is substantially the same as that of the peripheral wall 12B of the suction housing 12, and the inverter cover 41 is arranged so that the outer peripheral surface of the peripheral wall 41B forms a continuous surface with the peripheral surface of the peripheral wall 12B. Therefore, the capacitor holder 44 and the electrolytic capacitors 45 are positioned radially inward of an axially extended imaginary line of the peripheral wall 12B of the suction housing 12, that is, radially inward of an imaginary extension of an outline of the suction housing 12, the imaginary extension extending in the axial direction.

The base member 43 has a plurality of fifth threaded holes 43F and a plurality of sixth threaded holes 43G (see FIG. 2) into which the screws 54 and 55 are threadedly inserted to fix the power semiconductor module 48 and the inner connector 49 to the base member 43 at positions radially inward of the first mounting legs 43C1 and the second mounting legs 43E1. The fifth threaded holes 43F and the sixth threaded holes 43G are not formed through the base member 43, but formed halfway in the base member 43. The power semiconductor module 48 and the inner connector 49 are fixed to the base member 43 by tightening the screws 54 and 55 which are passed through the power semiconductor module 48 and the inner connector 49 into the fifth threaded holes 43F and the sixth threaded holes 43G, respectively. In this case, the power semiconductor module 48 and the inner connector 49 are disposed between the circuit board 47 and the base member 43 (see FIG. 1).

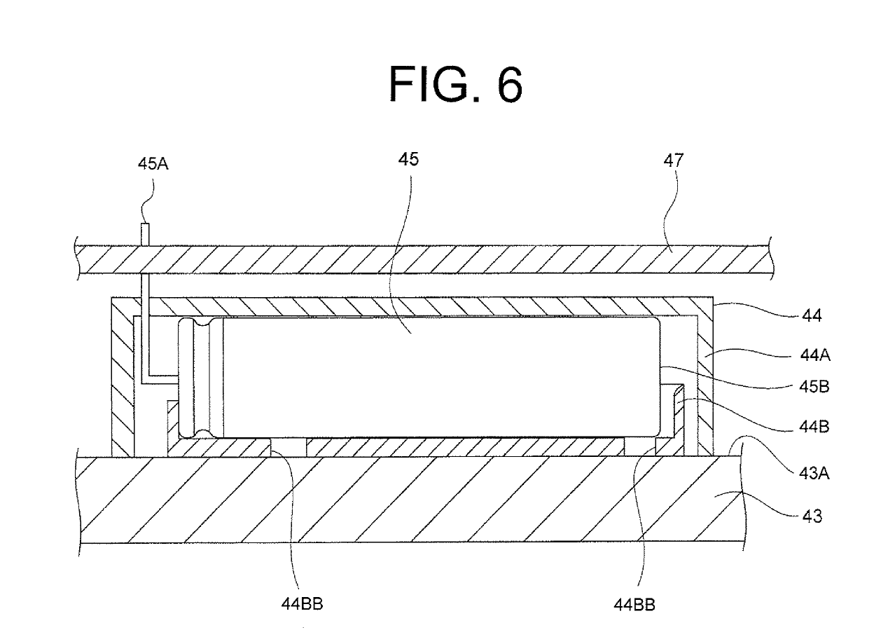

FIGS. 5 and 6 show the configuration of the capacitor holder 44 more in detail.

The capacitor holder 44 includes a support member 44B on which a plurality of columnar electrolytic capacitors 45 are mounted and a lid-shaped casing member 44A which is attached to the support member 44B in such a manner as to cover the support member 44B, the electrolytic capacitors 45 and the coil 46.

With the capacitor holder 44 mounted in place on the base member 43 (see FIG. 3), the support member 44B is placed on the surface 43A of the base member 43 (see FIG. 6). In such an arrangement, the open end of the casing member 44A is abutted in contact with the surface 43A of the base member 43 so as to entirely enclose the electrolytic capacitors 45 and the coil 46 together with the base member 43. Specifically, the casing member 44A covers the electrolytic capacitors 45 and the coil 46 from the end wall 41A side and the peripheral wall 41B side of the inverter cover 41 (see FIG. 1).

The support member 44B of the capacitor holder 44 is fixed to the surface 43A to the base member 43 so that the axis of the columnar electrolytic capacitors 45 fixed to the support member 44B is parallel to the surface 43A. In other words, the support member 44B supports the electrolytic capacitors 45 so that the end faces of the electrolytic capacitors 45 from which the busbars 45A extend out are perpendicular to the surface 43A. Therefore, the axes of the electrolytic capacitors 45 and the axis of the rotating shaft 50 (see FIG. 1) are substantially in perpendicular relation to each other. Therefore, with the support member 44B having therein the electrolytic capacitors 45 mounted to the base member 43, the height dimension of the electrolytic capacitors 45 that extend from the base member 43 in the axial direction of the rotating shaft 50 is reduced.

The casing member 44A has a plurality of engagement tabs 44AE, as well as the fixation tabs 44AC, each formed integrally with and projecting outwardly from the casing member 44A and having therethrough a rectangular hole. The support member 44B further has a plurality of retainers 44BA which are prismatic columnar projections having an arrowhead on one end thereof. The casing member 44A is assembled and fixed to the support member 44B by click-engaging the arrowheads of the retainers 44BA with the respective holes of the engagement tabs 44AE.

In the capacitor holder 44 housing the electrolytic capacitors 45 and the coil 46, a potting compound is applied between the support member 44B and the base member 43 (see FIG. 6) and between the coil 46 and the base member 43. Then the capacitor holder 44 is placed on the base member 43 and fixed at the fixation tabs 44AC with the screws 52 (see FIG. 3). The potting compound thus applied then passes through through holes 44BB formed through the support member 44B at the bottom thereof, permeates into the periphery of the electrolytic capacitors 45 and cures thereby to fix the capacitor holder 44, the electrolytic capacitors 45 and the base member 43 integrally. By so doing, the vibration resistance and the heat dissipation performance of the electrolytic capacitors 45 and the coil 46 are enhanced.

Furthermore, in the event that any deformation occurs in the electrolytic capacitors 45 due to a strong impact applied through the capacitor holder 44, the fluid in each of the electrolytic capacitors 45 may flow out from the end face 45B which does not have the busbar 45A. In the electric compressor 100 according to the present embodiment wherein the electrolytic capacitors 45 are covered with the casing member 44A of the capacitor holder 44, however, the fluid flowed out of the electrolytic capacitors 45 is not scattered therearound but is held temporarily in the capacitor holder 44. Thus, leakage of the fluid out of the capacitor holder 44 is prevented.

As shown in FIG. 4, in the capacitor holder 44 mounted to the base member 43, the first portion 44AA housing therein the electrolytic capacitors 45 is disposed at a position radially inward of the metallic first mounting legs 43C1 and the second mounting legs 43E1, which protects the first portion 44AA from being hit against the peripheral wall 41B (see FIG. 1) of the inverter cover 41. The first portion 44AA is also protected by the circuit board 47 from being hit against the end wall 41A of the inverter cover 41.

Furthermore, because the protrusion of the electrolytic capacitors 45 in the inverter cover 41 is small, the protrusion of the inverter cover 41 toward the end wall 41A (axial direction of the rotating shaft 50) is also small. Furthermore, the peripheral wall 41B of the inverter cover 41 has substantially the same cross-sectional profile as that of the peripheral wall 12B of the suction housing 12 (see FIG. 1) without extending radially outward of the peripheral wall 128. Therefore, in the case of hitting against the peripheral wall 41B, the metallic suction housing 12 receives most part of the impact applied, so that the first portion 44AA which is protected by the metallic first mounting legs 43C1 and the second mounting legs 43E1 in the inverter cover 41 is less susceptible to impact damage by hitting.

The electric compressor 100 according to the above embodiment of the present invention has the compression mechanism 20 which compresses and discharges refrigerant gas, the electric motor 30 which drives the compression mechanism 20 through the rotating shaft 50, the inverter circuit portion 40 which controls operation of the electric motor 30, and these components are disposed along the axial direction of the rotating shaft 50. The electric compressor 100 further includes the housing 10 which accommodates the compression mechanism 20 and the electric motor 30 and the inverter cover 41 which is connected to the housing 10 and accommodates therein the inverter circuit portion 40. The inverter circuit portion 40 is supported by the base member 43 which is mounted to the housing 10. The inverter circuit portion 40 has the electrolytic capacitors 45 that are mounted to the base member 43 in such an orientation that the longitudinal axes of the columnar electrolytic capacitors 45 intersect the axis of the rotating shaft 50 and the capacitor holder 44 for housing the electrolytic capacitors 45. The base member 43 includes a plurality of first and second mounting legs 43C1, 43E1 into which the screws 51, 53 are tightened, respectively, and the electrolytic capacitors 45 and the capacitor holder 44 are disposed at a position radially inward of the first and second mounting legs 43C1, 43E1 and also radially inward of an imaginary extension of the outline of the housing 10, the imaginary extension extending in the axial direction.

The provision of the capacitor holder 44 helps to reduce the load applied to the electrolytic capacitors 45 at a time of collision of a vehicle which is equipped with the electric compressor 100. Furthermore, since the capacitor holder 44 having therein the electrolytic capacitors 45 is disposed at a position radially inward of the first and second mounting legs 43C1, 43E1, the collision load caused by any collision of a vehicle is received by the first and second mounting legs 43C1, 43E1 and the load applied to the electrolytic capacitors 45 is reduced. Additionally, the capacitor holder 44 is disposed at a position radially inward of an imaginary extension of the outline of the housing 10, the imaginary extension extending in the axial direction. Therefore, most part of the collision load applied in the direction perpendicular to the axis of the rotating shaft 50 is received by the housing 10, so that the collision load applied to the electrolytic capacitor 45 is reduced. Therefore, the electric compressor 100 enables reduction of the collision load applied to the electrolytic capacitors 45 at a time of collision of a vehicle equipped with the electric compressor 100.

In the electric compressor 100, the capacitor holder 44 having therein the electrolytic capacitors 45 is enclosed with the base member 43 and the inverter cover 41 that is fixed to the first mounting legs 43C1. With this configuration, the capacitor holder 44 and hence the electrolytic capacitors 45 housed in the capacitor holder 44 are protected by the base member 43 and the inverter cover 41, and the load applied to the electrolytic capacitors 45 at a time of collision of a vehicle is reduced.

In the electric compressor 100, the inverter circuit portion 40 includes the circuit board 47, and the circuit board 47 is fixed to the second mounting legs 43E1 with the electrolytic capacitors 45 and the capacitor holder 44 disposed between the base member 43 and the circuit board 47. With this configuration, the electrolytic capacitors 45 and the capacitor holder 44 are protected also by the circuit board 47.

In the electric compressor 100, the base member 43 and the first and second mounting legs 43C1, 43E1 which are made of metal and formed integrally have an enhanced strength, thus providing a strong protection for the electrolytic capacitor 45 and the capacitor holder 44.

In the electric compressor 100 according to the present embodiment, the base member 43 is formed so as to enclose the capacitor holder 44 together with the first mounting legs 43C1 for fixing the inverter cover 41 and the second mounting legs 43E1 for fixing the circuit board 47. According to the present invention, however, it may be so configured that the capacitor holder 44 is enclosed by the base member 43 and the first mounting legs 43C1 only. Alternatively, the base member 43 may have additional mounting legs that enclose the capacitor holder 44 with these first and second mounting legs 43C1, 43E1.

In the electric compressor 100 according to the present embodiment, the base member 43 is formed so that a part of the second portion 44AB of the capacitor holder 44 and the fixation tabs 44AC are positioned outside the region having a boundary defined by the positions of the first and second mounting legs 43C1, 43E1. According to the present invention, however, the base member 43 may be formed so that the entirety of the second portion 44AB of the capacitor holder 44 and the fixation tabs 44AC are positioned within the region having a boundary defined by the positions of the first and second mounting legs 43C1, 43E1.

In the electric compressor 100 according to the present embodiment, the electrolytic capacitors 45 are disposed so that the longitudinal axes thereof extend substantially perpendicular to the axis of the rotating shaft 50. According to the present invention, however, the electrolytic capacitors 45 may be disposed so that the longitudinal axes thereof intersect the axis of the rotating shaft 50. Even in this case, the axial length of the electrolytic capacitors 45 and hence the axial length of the inverter cover 41 extending from the end wall 12A of the suction housing 12 are reduced. It is to be noted that a film capacitor may alternatively be used as the capacitor of the present invention. In this case, the film capacitor having the shape of a flat box is mounted to the base portion so that the edge of the cuboid which is the largest of the three perpendicular edges thereof intersects the axis of the base portion. In other words, the film capacitor is mounted to the base portion in such an orientation that the longitudinal direction of the film capacitor intersects the axis of the base portion.

In the electric compressor 100 according to the present embodiment, the discharge housing 11, the suction housing 12, and the inverter cover 41 are serially connected in this order. According to the present invention, however, the inverter cover 41 may be connected to the discharge housing 11.

Although the electric compressor 100 has been described as a scroll type electric compressor, the type of the electric compressor is not limited to the scroll type, but compressors of any other types may be used as long as they have an electric motor and an electrical circuit.

What is claimed is:

1. An electric compressor in which a compression mechanism which compresses and discharges fluid, an electric motor which drives the compression mechanism through a rotating shaft thereof and a drive circuit portion which controls operation of the electric motor are disposed along the axis of the rotating shaft, comprising:
a housing which accommodates therein the compression mechanism and the electric motor; and
to a cover which is joined to the housing and accommodates therein the drive circuit portion, wherein
the drive circuit portion is supported by a base portion which is mounted to the housing;
the drive circuit portion has a capacitor which is mounted to the base portion in such an orientation that the longitudinal direction of the capacitor intersects the axis of the rotating shaft and a capacitor holder for housing the capacitor;
the base portion has a plurality of receiving portions into which fasteners are tightened; and
the capacitor and the capacitor holder are disposed at a position radially inward of the receiving portions and also radially inward of an imaginary extension of an outline of the housing, the imaginary extension extending in the axial direction.

2. The electric compressor according to claim 1, wherein
the capacitor and the capacitor holder are entirely enclosed with the base portion and the cover; and
the cover is fixed to the receiving portions.

3. The electric compressor according to claim 1, wherein
the drive circuit portion has a circuit board;
the circuit board is fixed to the receiving portions; and
the capacitor and the capacitor holder are disposed between the base portion and the circuit board.

4. The electric compressor according to claim 1, wherein the base portion and the receiving portions are made of metal and formed integrally.

5. The electric compressor according to claim 1, wherein the capacitor is an electrolytic capacitor.
